(19) United States
(12) Patent Application Publication
(10) Pub. No.: US 2025/0320777 A1
(43) Pub. Date: Oct. 16, 2025

(54) INTELLIGENT DUAL-DRIVE CURTAIN SYSTEM

(71) Applicant: Mingyang Windeco Technology Corporation, Zhengzhou (CN)

(72) Inventors: Nianqing ZHANG, Zhengzhou (CN); Junxiang YAN, Zhengzhou (CN); Pengyu YANG, Zhengzhou (CN); Liu CUN, Zhengzhou (CN); Kunpeng PU, Zhengzhou (CN); Gang ZHOU, Zhengzhou (CN); Yuwei HU, Zhengzhou (CN); Yongqing KANG, Zhengzhou (CN); Shehua WEI, Zhengzhou (CN); Peilun QIAN, Zhengzhou (CN)

(21) Appl. No.: 18/903,808

(22) Filed: Oct. 1, 2024

(30) Foreign Application Priority Data
Apr. 12, 2024 (CN) 202410440582.9

(51) Int. Cl. E06B 9/74; E06B 9/44; E06B 9/50; E06B 9/68; E06B 9/72

(52) U.S. Cl. CPC E06B 9/74; E06B 9/44; E06B 9/50; E06B 9/72; E06B 2009/6845

(57) ABSTRACT

An intelligent dual-drive curtain system, which includes a roll tube, wherein the roll tube is wound with curtain cloth, and one end of the curtain cloth is fixed with a lower beam. The roll tube is equipped with a tubular motor and a spring rod drive unit. The tubular motor includes a power supply, a circuit board, a driving motor, a reducer, and an output shaft. The spring rod drive unit is clamped with the output shaft, and the output shaft rotates synchronously with the roll tube. The output shaft is also fixedly connected to the rotation shaft of the reducer, and the reducer is fixedly connected to the rotation shaft of the driving motor. The rotation shaft of the driving motor is on the end far from the reducer and is connected to the rotation shaft of the driving motor. A magnetic ring is fixedly installed, and a Hall sensing unit is installed at any position along the circumference of the magnetic ring. The Hall sensing unit and the driving motor are both electrically connected to the circuit board, The circuit board is electrically connected to the power supply, which improves the speed of curtain opening and closing.

### TECHNICAL FIELD

The present disclosure belongs to the technical field of curtains, and specifically relates to an intelligent dual-drive curtain system.

### BACKGROUND

As an indispensable part of life, curtain products have gradually become more and more demanding with the improvement of material life. Especially in recent years, conventional pull bead or pull rope systems for curtains have been gradually replaced with pull rope-free curtain systems and electric curtain systems with regard to child safety protection. However, during use of a pull rope-free curtain, if the curtain is too high, the curtain is very inconvenient to fully retract or is inconvenient to extend after being retracted due to the incapability of reaching a lower beam during operation.

A motor of an existing electric curtain needs to be controlled by a remote controller during use, and the remote controller is easily thrown away at will during use, resulting in a bad experience of operating the curtain.

### SUMMARY

To solve the above technical problems, the present disclosure provides an intelligent dual-drive curtain system.

A specific solution is as follows:

An intelligent dual-drive curtain system, comprising a roll tube, wherein curtain cloth is wound around the roll tube, a lower beam is fixed at one end of the curtain cloth, a tubular motor and a spring rod driving unit are disposed in the roll tube, the tubular motor comprises a power supply, a circuit board, a driving motor, a speed reducer, and an output rotating shaft, the spring rod driving unit is in clamped connection with the output rotating shaft, the output rotating shaft rotates synchronously with the roll tube, the output rotating shaft is further fixedly connected to a rotating shaft of the speed reducer, the speed reducer is fixedly connected to a rotating shaft of the driving motor, a magnetic ring is fixedly disposed at one end of the rotating shaft of the driving motor away from the speed reducer, a Hall sensing unit is disposed at any position along the circumference of the magnetic ring, the Hall sensing unit and the driving motor are both electrically connected to the circuit board, and the circuit board is electrically connected to the power supply.

The tubular motor further comprises a tubular housing, the power supply, the circuit board, the driving motor, the speed reducer, and the output rotating shaft are all fixed in the tubular housing, one end of the tubular housing is in clamped connection with the spring rod driving unit by the output rotating shaft, and the output rotating shaft is connected to the tubular housing in a relative rotation manner.

The spring rod driving unit comprises a support rod, a first connector is fixedly disposed on the support rod, the support rod is in clamped connection with the output rotating shaft by the first connector, first radial plates are uniformly disposed on the first connector, the first connector is in clamped connection with the output rotating shaft by the first radial plates, a rotating wheel is further fixedly disposed on the output rotating shaft, a clamping hole is formed on an end surface of the rotating wheel away from the speed reducer, second radial plates are uniformly disposed in the clamping hole, the second radial plates are staggered from the first radial plates, convex strips are uniformly disposed on the rotating wheel, and the convex strips are in clamped connection with grooves on an inner wall of the roll tube.

A chuck and a torsion spring are further disposed on the support rod, one end of the torsion spring is fixedly connected to the support rod, the other end of the torsion spring is fixedly connected to the chuck, a bearing is disposed in the chuck, the chuck is connected to the support rod in a relative rotation manner by the bearing, a clamping recess is formed on the chuck, and a clamping bump matched with the clamping hole is disposed on the inner wall of the roll tube.

The intelligent dual-drive curtain system further comprising a housing, wherein a bracket is fixed at each of two ends of the housing, a clamping column is disposed on the bracket, a crown wheel is fixedly disposed at one end of the tubular motor extending out of the roll tube, a second connector is disposed at one end of the spring rod driving unit extending out of the roll tube, the second connector is connected to the spring rod driving unit in a relative rotation manner, a clamping groove is formed on each of the crown wheel and the second connector, the crown wheel is in clamped connection with the bracket at one end of the housing, the second connector is in clamped connection with the bracket at the other end of the housing, a sealing cover is disposed on each of the brackets at the two ends of the housing, and the sealing cover is connected to the bracket by a buckle.

A cover plate is further disposed on the crown wheel, a power switch and a power charging protection board are disposed in the cover plate, the power switch and the power charging protection board are both electrically connected to the power supply, a charging connection wire is disposed on the power charging protection board, and the charging connection wire is electrically connected to the charging protection board.

The Hall sensing unit comprises a first Hall sensor and a second Hall sensor which are fixed at different positions beside the magnetic ring.

The power supply is a lithium battery, a controller is further disposed on the circuit board, the driving motor and the Hall sensing unit are both electrically connected to the controller, and the controller is a single-chip microcomputer.

The intelligent dual-drive curtain system further comprising a remote controller in wireless communication connection with the circuit board.

The present invention provides an intelligent dual-drive curtain system, including a roll tube, where curtain cloth is wound around the roll tube, a lower beam is fixed at one end of the curtain cloth, and a tubular motor and a spring rod driving unit are disposed in the roll tube. During operation, the lower beam of a curtain is gently pulled to break a suspended state of the curtain, the lower beam will drive a fabric and the roll tube to rotate for triggering a rotating wheel of the motor in the roll tube to rotate for starting the motor, such that the curtain is automatically extended to a limit point. When the curtain needs to be retracted, only the lower beam needs to be pushed, and a spring driving force breaks the suspended state of the curtain due to a force of pushing the lower beam upwards. The spring driving force is greater than a torque of the motor and drives the roll tube to rotate for triggering the rotating wheel of the motor in the roll tube to rotate for starting the motor, such that the curtain is driven by the motor to be automatically retracted to a limit point, thereby increasing a speed of curtain extension and retraction, and providing a better experience.

### BRIEF DESCRIPTION OF THE DRAWINGS

FIG. 1 is a schematic structural diagram of a roll tube, a tubular motor, and a spring rod driving unit;

FIG. 2 is a schematic structural diagram of an interior of a tubular motor;

FIG. 3 is a schematic structural diagram of a magnetic ring and a Hall sensing unit;

FIG. 4 is a schematic structural diagram in which a Hall sensing unit senses a magnetic ring;

FIG. 5 is a schematic structural diagram of an exterior of a tubular motor;

FIG. 6 is a schematic structural diagram of a spring rod driving unit;

FIG. 7 is a schematic structural diagram in which a rotating wheel is matched with a first connector by means of clamped connection;

FIG. 8 is a schematic structural diagram in which one end of a housing is connected to a bracket;

FIG. 9 is a schematic structural diagram in which the other end of a housing is connected to a bracket;

FIG. 10 is a schematic structural diagram of a bracket and a sealing cover;

FIG. 11 is a schematic structural diagram of a crown wheel;

FIG. 12 is a schematic structural diagram of a second connector; and

FIG. 13 is a schematic exploded view of an intelligent dual-drive curtain system.

### DETAILED DESCRIPTION OF THE EMBODIMENTS

The technical solutions in the embodiments of the present disclosure will be described below with reference to the accompanying drawings in the present disclosure. Apparently, the described embodiments are merely some rather than all of the embodiments of the present disclosure. All other embodiments derived by those of ordinary skill in the art based on the embodiments of the present disclosure without creative efforts shall fall within the scope of protection of the present disclosure.

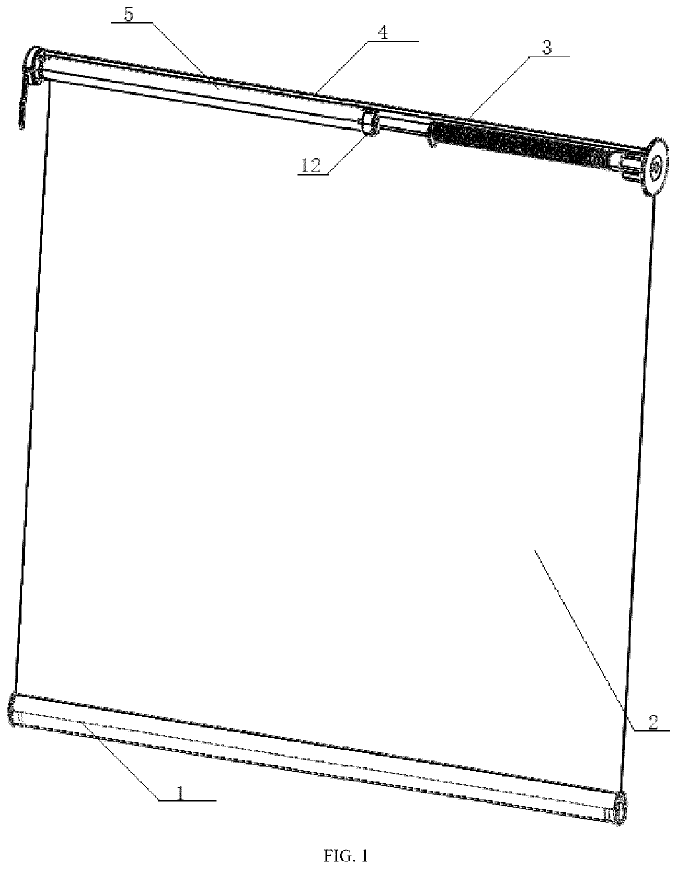

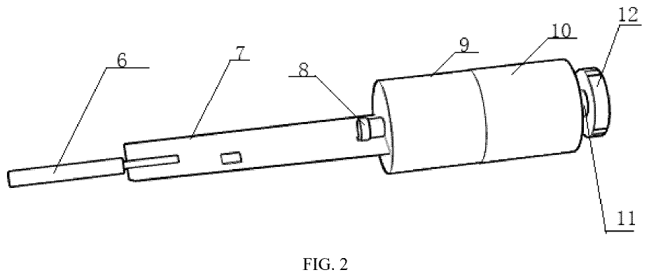

As shown in FIG. 1 to FIG. 4, an intelligent dual-drive curtain system includes a roll tube 4, where curtain cloth 2 is wound around the roll tube 4, a lower beam 1 is fixed at one end of the curtain cloth 2, a tubular motor 5 and a spring rod driving unit 3 are disposed in the roll tube 4, the tubular motor 5 includes a power supply 6, a circuit board 7, a driving motor 9, a speed reducer 10, and an output rotating shaft 11, the spring rod driving unit 3 is in clamped connection with the output rotating shaft 11, the output rotating shaft 11 rotates synchronously with the roll tube 4, the output rotating shaft 11 is further fixedly connected to a rotating shaft of the speed reducer 10, the speed reducer 10 is fixedly connected to a rotating shaft of the driving motor 9, a magnetic ring 8 is fixedly disposed at one end of the rotating shaft of the driving motor 9 away from the speed reducer 10, a Hall sensing unit 13 is disposed at any position along the circumference of the magnetic ring 8, the Hall sensing unit 13 and the driving motor 9 are both electrically connected to the circuit board 7, and the circuit board 7 is electrically connected to the power supply 6.

As shown in FIG. 5, the tubular motor 5 further includes a tubular housing 14, where the power supply 6, the circuit board 7, the driving motor 9, the speed reducer 10, and the output rotating shaft 11 are all fixed in the tubular housing 14, one end of the tubular housing 14 is in clamped connection with the spring rod driving unit 3 by the output rotating shaft 11, and the output rotating shaft 11 is connected to the tubular housing 14 in a relative rotation manner.

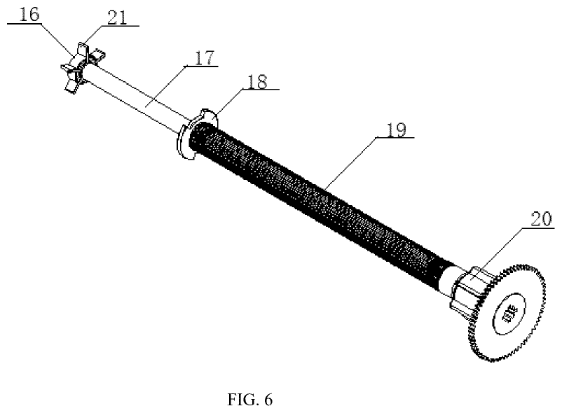

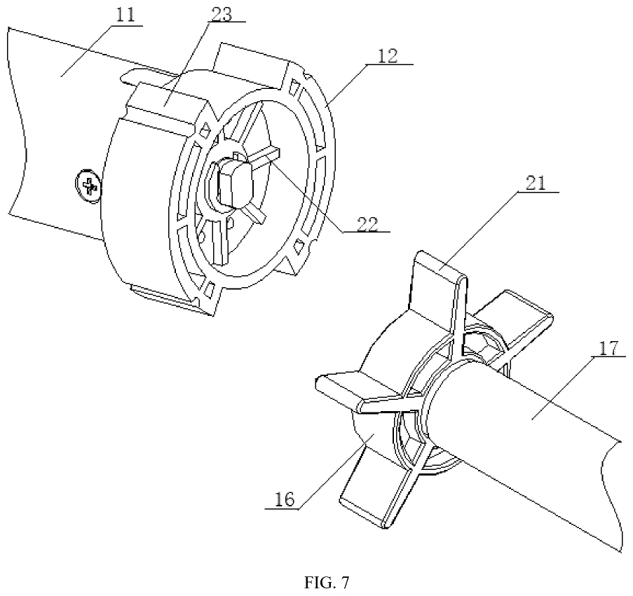

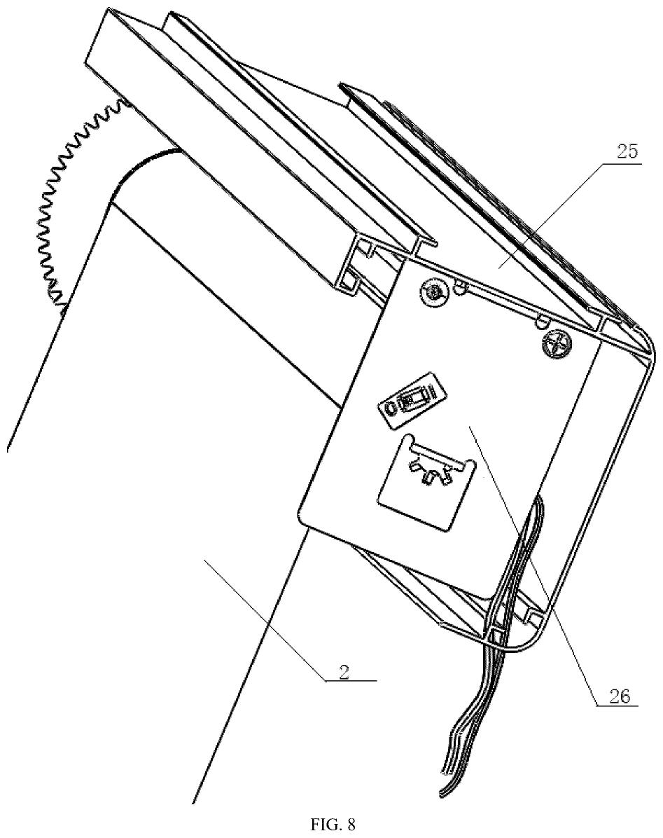

As shown in FIG. 6 and FIG. 7, the spring rod driving unit 3 includes a support rod 17, where a first connector 16 is fixedly disposed on the support rod 17, the support rod 17 is in clamped connection with the output rotating shaft 11 by the first connector 16, first radial plates 21 are uniformly disposed on the first connector 16, the first connector 16 is in clamped connection with the output rotating shaft 11 by the first radial plates 21, a rotating wheel 12 is further fixedly disposed on the output rotating shaft 11, a clamping hole is formed on an end surface of the rotating wheel 12 away from the speed reducer 10, second radial plates 22 are uniformly disposed in the clamping hole, the second radial plates 22 are staggered from the first radial plates 21, convex strips 23 are uniformly disposed on the rotating wheel 12, and the convex strips 23 are in clamped connection with grooves on an inner wall of the roll tube 4.

A chuck 18 and a torsion spring 19 are further disposed on the support rod 17, one end of the torsion spring 19 is fixedly connected to the support rod 17, the other end of the torsion spring 19 is fixedly connected to the chuck 18, a bearing is disposed in the chuck 18, the chuck 18 is connected to the support rod 17 in a relative rotation manner by the bearing, a clamping recess 24 is formed on the chuck 18, and a clamping bump matched with the clamping hole is disposed on the inner wall of the roll tube 4.

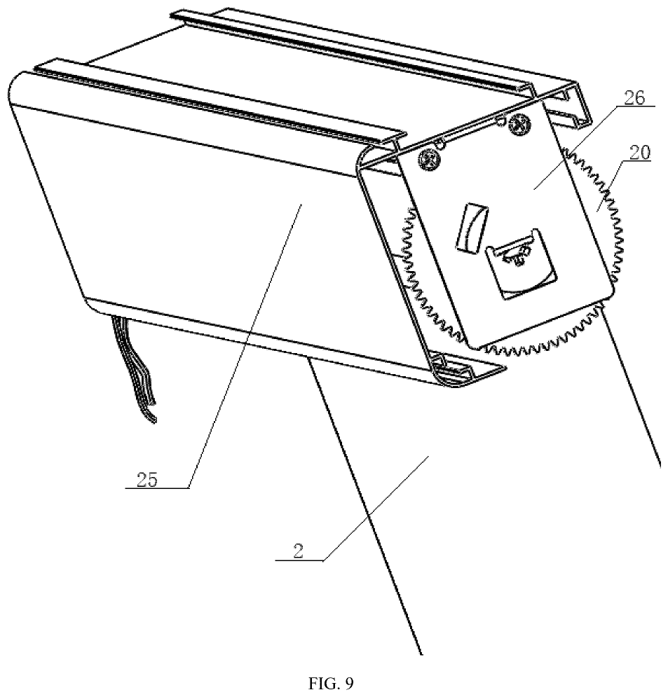

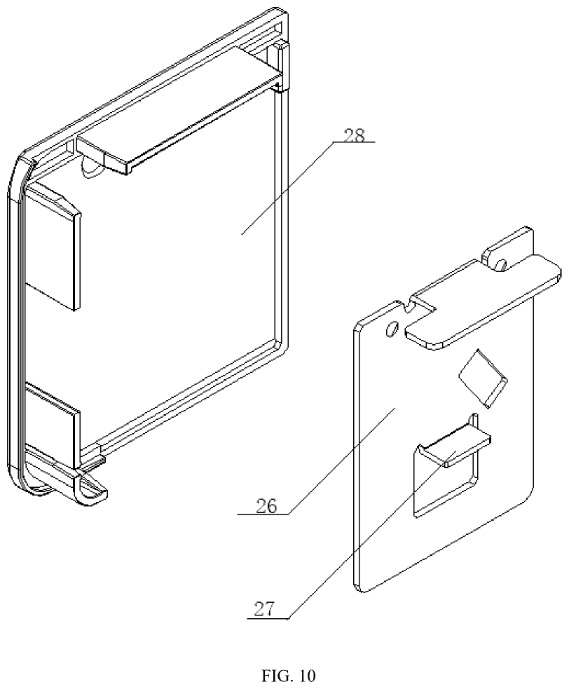

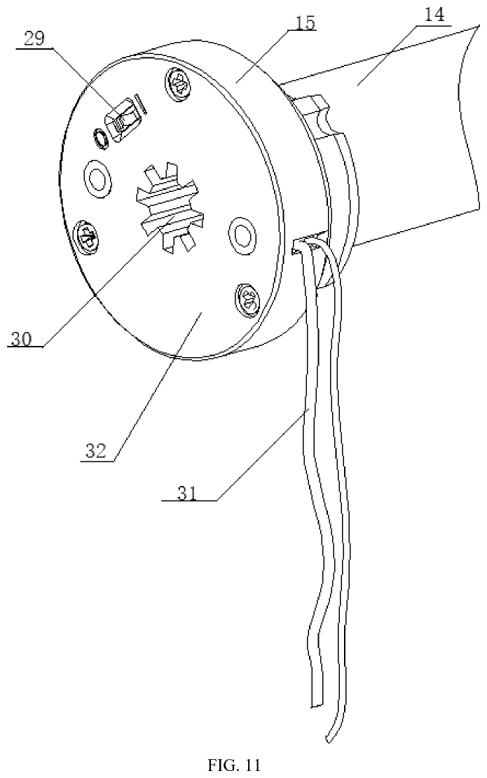

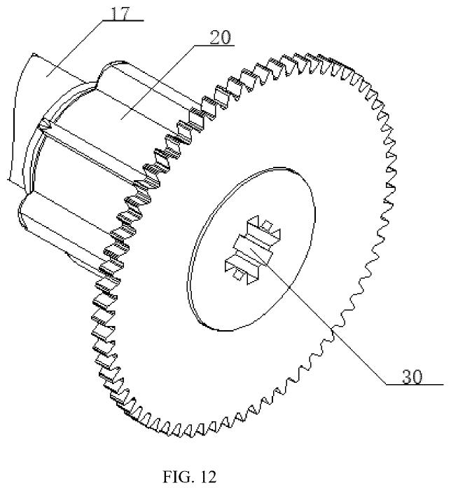

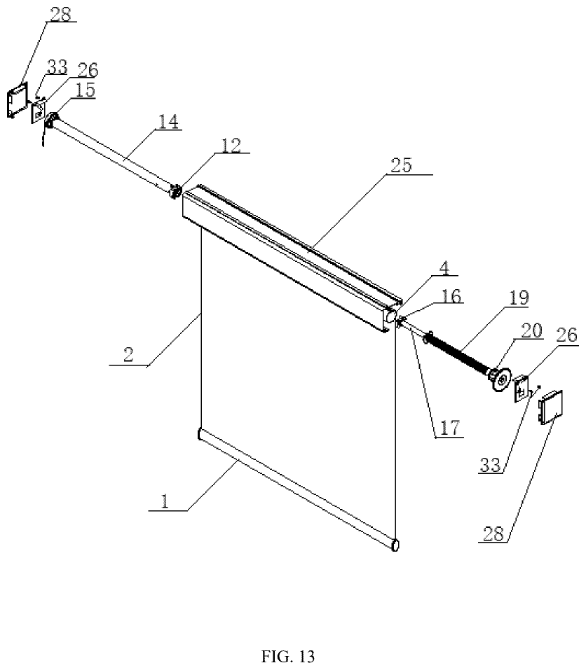

As shown in FIG. 8 to FIG. 13, the curtain system further includes a housing 25, where a bracket 26 is fixed at each of two ends of the housing 25, a clamping column 27 is disposed on the bracket 26, a crown wheel 15 is fixedly disposed at one end of the tubular motor 5 extending out of the roll tube 4, a second connector 20 is disposed at one end of the spring rod driving unit 3 extending out of the roll tube 4, the second connector 20 is connected to the spring rod driving unit 3 in a relative rotation manner, a clamping groove 30 is formed on each of the crown wheel 15 and the second connector 20, the crown wheel 15 is in clamped connection with the bracket 26 at one end of the housing 25, the second connector 20 is in clamped connection with the bracket 26 at the other end of the housing 25, a sealing cover 28 is disposed on each of the brackets 26 at the two ends of the housing 25, the sealing cover 28 is connected to the bracket 26 by a buckle, and the bracket is fixedly connected to the housing 25 by a screw 33.

A cover plate 32 is further disposed on the crown wheel 15, a power switch 29 and a power charging protection board are disposed in the cover plate 32, the power switch 29 and the power charging protection board are both electrically connected to the power supply 6, a charging connection wire 31 is disposed on the power charging protection board, and the charging connection wire 31 is electrically connected to the charging protection board. The charging protection board has a power detection function. When the power of the power supply is too low, for example, the power is less than 20%, the motor operating a curtain will make an alarm sound to prompt a user to perform charging in time. A limit point set for the motor is easy to lose under the condition that the power is exhausted. Especially a standby battery is arranged in the motor connected to the power supply to maintain the existence of the limit point.

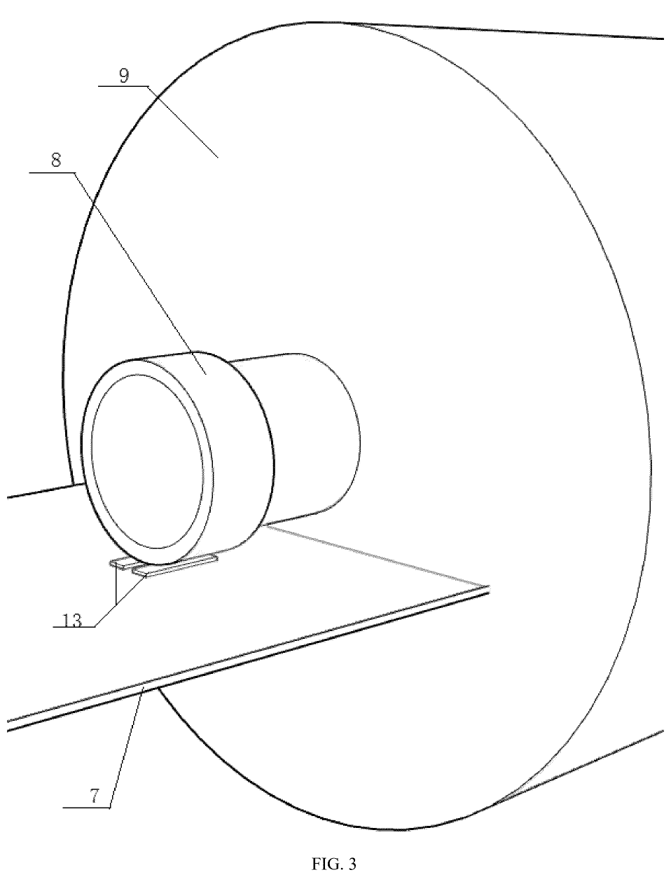

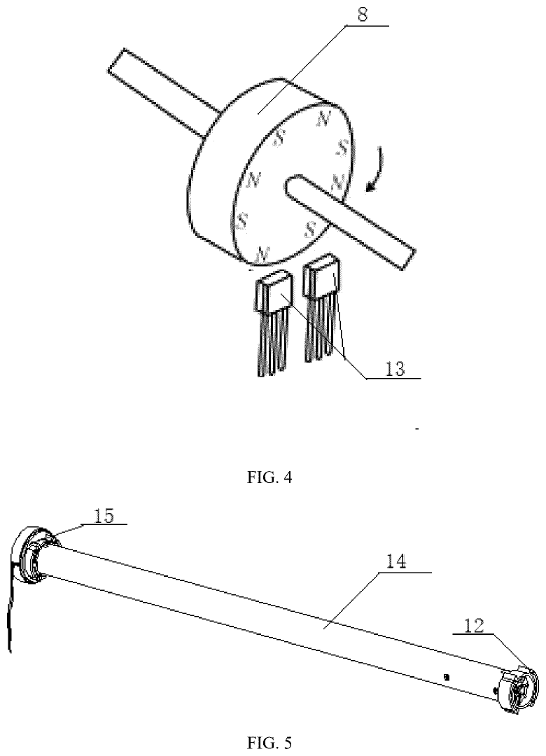

As shown in FIG. 3 and FIG. 4, the Hall sensing unit 13 includes a first Hall sensor and a second Hall sensor which are fixed at different positions beside the magnetic ring 8. The first Hall sensor and the second Hall sensor are disposed at different positions to detect a rotational direction of the magnetic ring 8. The rotational direction of the magnetic ring 8 is determined based on different phases sensed by the first Hall sensor and the second Hall sensor. The first Hall sensor and the second Hall sensor transmit the sensed phases to a controller. The controller drives the motor to rotate clockwise or counterclockwise based on the phases.

In this embodiment, the number of output revolutions of the motor 9 is N1, the number of output revolutions of the speed reducer 10 is N2, and a speed ratio of the motor to the speed reducer is N1/N2, where N1<N2. When a variation of the rotating wheel 12 is n turns, a variation of the rotating shaft of the motor 9 is n*N2/N1. The variation of the rotating shaft of the motor 9 is greater than the variation of the rotating wheel 12, such that the rotating shaft of the motor has good sensitivity.

The power supply 6 is a lithium battery, a controller is further disposed on the circuit board 7, the driving motor 9 and the Hall sensing unit 13 are both electrically connected to the controller, and the controller is a single-chip microcomputer.

The system further includes a remote controller in wireless communication connection with the circuit board 7.

A specific working process of the manual and electrical integrated curtain system is as follows:

When the curtain needs to be pulled down, the lower beam 1 is manually pulled, and the lower beam 1 drives the roll tube 4 to rotate by the curtain cloth. As shown in FIG. 1, when the curtain cloth is manually pulled down, the roll tube 4 rotates clockwise, as seen from the right side of FIG. 1. When the roll tube 4 rotates clockwise, both the rotating wheel 12 and the support rod 17 will be driven to rotate clockwise in the roll tube 4. When the support rod 17 rotates clockwise, the torsion spring 19 starts to accumulate a force, as shown in FIG. 6. When the rotating wheel 12 rotates clockwise, the speed reducer 10 starts to rotate clockwise. The rotation of the speed reducer 10 drives the rotating shaft of the motor 9 to start to rotate clockwise. While the rotating shaft of the motor 9 rotates clockwise, the magnetic ring 8 on the rotating shaft will be driven to rotate clockwise. When the Hall sensing unit 13 senses the clockwise rotation of the magnetic ring 8, an electric signal after sensing is transmitted to the controller by the circuit board 7, then the controller drives the motor 9 to be started, and the rotating shaft of the motor 9 started rotates clockwise. The rotating shaft of the motor 9 drives the rotating wheel 12 to rotate clockwise by the speed reducer 10. At this time, the rotating wheel 12 drives the roll tube 4 to rotate clockwise, such that the curtain cloth starts to descend under the drive of the motor 9, without being manually pulled down.

In the process that the motor 9 is started to rotate, the torsion spring 19 on the support rod 17 further accumulates a force. When the curtain descends to the limit point, a resultant force of the accumulated force on the torsion spring and a torque of the motor shaft is equal to a resultant force of a gravity of the curtain and a gravity of the lower beam. At this time, force balance is implemented, and the curtain is in a suspended state at the lower limit point.

In the process that the curtain descends, the Hall sensing unit records a rotation number of the motor shaft. A preset rotation number under the condition of reaching the lower limit point of the curtain is pre-stored in the controller. When the rotation number of the motor is equal to the preset rotation number, the controller drives the motor to stop rotating.

When the curtain needs to be pulled up, the lower beam 1 is manually lifted. As the lower beam 1 is lifted, the gravity of the lower beam disappears, and the force balance is broken. At this time, the accumulated force in the torsion spring 19 starts to be released, and the torsion spring 19 drives the rotating wheel 12 to rotate. As seen from the right side of FIG. 1, the rotating wheel 12 rotates counterclockwise. While the rotating wheel 12 rotates counterclockwise, the roll tube 4 is driven to rotate counterclockwise. In this way, the roll tube 4 starts to roll up the curtain cloth to pull up the curtain.

While the rotating wheel 12 rotates counterclockwise, both the speed reducer 10 and the rotating shaft of the motor 9 rotate counterclockwise. The counterclockwise rotation of the rotating shaft of the motor 9 drives the magnetic ring 8 on the rotating shaft to rotate counterclockwise. When the Hall sensing unit 13 detects the counterclockwise rotation of the magnetic ring, an electric signal after sensing is transmitted to the controller by the circuit board 7, the controller drives the motor 9 to be started, and at this time, the rotating shaft of the motor 9 rotates counterclockwise.

The counterclockwise rotation of the rotating shaft of the motor 9 drives both the speed reducer 10 and the rotating wheel 12 to rotate counterclockwise. While the rotating wheel 12 rotates counterclockwise, the torque spring 19 further releases the accumulated force. The counterclockwise rotation of the roll tube 4 is accelerated under the action of the rotating wheel 12 and the torsion spring 19, thereby achieving the effect of quickly rolling up the curtain cloth 2, that is, implementing quick retraction of the curtain.

The present invention provides an intelligent dual-drive curtain system, including a roll tube, where curtain cloth is wound around the roll tube, a lower beam is fixed at one end of the curtain cloth, and a tubular motor and a spring rod driving unit are disposed in the roll tube. During operation, the lower beam of a curtain is gently pulled to break a suspended state of the curtain, the lower beam will drive a fabric and the roll tube to rotate for triggering a rotating wheel of the motor in the roll tube to rotate for starting the motor, such that the curtain is automatically extended to a limit point. When the curtain needs to be retracted, only the lower beam needs to be pushed, and a spring driving force breaks the suspended state of the curtain due to a force of pushing the lower beam upwards. The spring driving force is greater than a torque of the motor and drives the roll tube to rotate for triggering the rotating wheel of the motor in the roll tube to rotate for starting the motor, such that the curtain is driven by the motor to be automatically retracted to a limit point, thereby increasing a speed of curtain extension and retraction, and providing a better experience.

The technical means disclosed in the solution of the present disclosure not only are not limited to the technical means disclosed in the above embodiments, but also include the technical solution composed of any combination of the above technical features. It should be pointed out that several improvements and modifications can be made without departing from the principle of the present disclosure for those of ordinary skill in the technical field, and these improvements and modifications are also regarded as the scope of protection of the present disclosure.

What is claimed is:

1. An intelligent dual-drive curtain system, comprising a roll tube, wherein curtain cloth is wound around the roll tube, a lower beam is fixed at one end of the curtain cloth, a tubular motor and a spring rod driving unit are disposed in the roll tube, the tubular motor comprises a power supply, a circuit board, a driving motor, a speed reducer, and an output rotating shaft, the spring rod driving unit is in clamped connection with the output rotating shaft, the output rotating shaft rotates synchronously with the roll tube, the output rotating shaft is further fixedly connected to a rotating shaft of the speed reducer, the speed reducer is fixedly connected to a rotating shaft of the driving motor, a magnetic ring is fixedly disposed at one end of the rotating shaft of the driving motor away from the speed reducer, a Hall sensing unit is disposed at any position along the circumference of the magnetic ring, the Hall sensing unit and the driving motor are both electrically connected to the circuit board, and the circuit board is electrically connected to the power supply.

2. The intelligent dual-drive curtain system according to claim 1, wherein the tubular motor further comprises a tubular housing, the power supply, the circuit board, the driving motor, the speed reducer, and the output rotating shaft are all fixed in the tubular housing, one end of the tubular housing is in clamped connection with the spring rod driving unit by the output rotating shaft, and the output rotating shaft is connected to the tubular housing in a relative rotation manner.

3. The intelligent dual-drive curtain system according to claim 1, wherein the spring rod driving unit comprises a support rod, a first connector is fixedly disposed on the support rod, the support rod is in clamped connection with the output rotating shaft by the first connector, first radial plates are uniformly disposed on the first connector, the first connector is in clamped connection with the output rotating shaft by the first radial plates, a rotating wheel is further fixedly disposed on the output rotating shaft, a clamping hole is formed on an end surface of the rotating wheel away from the speed reducer, second radial plates are uniformly disposed in the clamping hole, the second radial plates are staggered from the first radial plates, convex strips are uniformly disposed on the rotating wheel, and the convex strips are in clamped connection with grooves on an inner wall of the roll tube.

4. The intelligent dual-drive curtain system according to claim 3, wherein a chuck and a torsion spring are further disposed on the support rod, one end of the torsion spring is fixedly connected to the support rod, the other end of the torsion spring is fixedly connected to the chuck, a bearing is disposed in the chuck, the chuck is connected to the support rod in a relative rotation manner by the bearing, a clamping recess is formed on the chuck, and a clamping bump matched with the clamping hole is disposed on the inner wall of the roll tube.

5. The intelligent dual-drive curtain system according to claim 1, further comprising a housing, wherein a bracket is fixed at each of two ends of the housing, a clamping column is disposed on the bracket, a crown wheel is fixedly disposed at one end of the tubular motor extending out of the roll tube, a second connector is disposed at one end of the spring rod driving unit extending out of the roll tube, the second connector is connected to the spring rod driving unit in a relative rotation manner, a clamping groove is formed on each of the crown wheel and the second connector, the crown wheel is in clamped connection with the bracket at one end of the housing, the second connector is in clamped connection with the bracket at the other end of the housing, a sealing cover is disposed on each of the brackets at the two ends of the housing, and the sealing cover is connected to the bracket by a buckle.

6. The intelligent dual-drive curtain system according to claim 5, wherein a cover plate is further disposed on the crown wheel, a power switch and a power charging protection board are disposed in the cover plate, the power switch and the power charging protection board are both electrically connected to the power supply, a charging connection wire is disposed on the power charging protection board, and the charging connection wire is electrically connected to the charging protection board.

7. The intelligent dual-drive curtain system according to claim 1, wherein the Hall sensing unit comprises a first Hall sensor and a second Hall sensor which are fixed at different positions beside the magnetic ring.

8. The intelligent dual-drive curtain system according to claim 1, wherein the power supply is a lithium battery, a controller is further disposed on the circuit board, the driving motor and the Hall sensing unit are both electrically connected to the controller, and the controller is a single-chip microcomputer.

9. The intelligent dual-drive curtain system according to claim 1, further comprising a remote controller in wireless communication connection with the circuit board.
